(19) United States
(12) Patent Application Publication
(10) Pub. No.: US 2022/0153226 A1
(43) Pub. Date: May 19, 2022

(54) SEATBELT DEVICE

(71) Applicants: TOYOTA JIDOSHA KABUSHIKI KAISHA, Toyota-shi Aichi-ken (JP); SUBARU CORPORATION, Tokyo (JP)

(72) Inventor: Atsuji Fujioka, Tokyo (JP)

(73) Assignees: TOYOTA JIDOSHA KABUSHIKI KAISHA, Toyota-shi Aichi-ken (JP); SUBARU CORPORATION, Tokyo (JP)

(21) Appl. No.: 17/481,791

(22) Filed: Sep. 22, 2021

(30) Foreign Application Priority Data
Nov. 19, 2020 (JP) 2020-192668

(51) Int. Cl. B60R 22/34

(52) U.S. Cl. CPC B60R 22/34

(57) ABSTRACT

A seatbelt device for a vehicle includes a retractor configured to store webbing, a bracket configured to be fixed to a frame within the vehicle, a bezel configured to be fixed to a skin material, and a protruding portion configured to be interposed between the bracket and the webbing. The bracket is configured to regulate a passage range of the webbing fed out from the retractor, at an inner side of the skin material covering the frame. The bezel includes a through hole. The webbing extending from the retractor to an outer side of the skin material is configured to pass through the through hole. The protruding portion extends from an inner face of the bezel toward the bracket.

### CROSS-REFERENCE TO RELATED APPLICATION

This application claims priority to Japanese Patent Application No. 2020-192668 filed on Nov. 19, 2020, incorporated herein by reference in its entirety.

### BACKGROUND

### 1. Technical Field

The technology disclosed in the present specification relates to a seatbelt device for a vehicle.

### 2. Description of Related Art

Japanese Unexamined Patent Application Publication No. 2014-218157 (JP 2014-218157 A) discloses a seatbelt device for a vehicle. This seatbelt device is provided with a retractor that stores webbing, a bracket fixed to a seat frame, and a bezel fixed to a seat skin material. The bracket regulates the range of passage of the webbing pulled out from the retractor at the inner side of the seat skin material (i.e., within the seat). A through hole is provided in the bezel, and the webbing extends to the outside of the seat skin material through this through hole.

### SUMMARY

When the vehicle is in a collision, for example, a great load is placed on the webbing. When a great load is placed on the webbing, the webbing is locked at the retractor.

As a result, further pulling out of the webbing is prohibited. Displacement of the webbing as to the seat is restricted by the bracket fixed to the seat frame. The webbing may come into intense contact (i.e., with a great relative velocity) with the bracket at this time. In doing so, the webbing may be damaged by unintended folding or twisting occurring in the webbing.

The present disclosure provides technology capable of suppressing damage of webbing in a seatbelt device.

The technology according to a first aspect of the present disclosure is realized as a seatbelt device for a vehicle. The seatbelt device includes a retractor configured to store webbing, a bracket configured to be fixed to a frame within the vehicle, a bezel configured to be fixed to a skin material, and a protruding portion configured to be interposed between the bracket and the webbing. The bracket is configured to regulate a passage range of the webbing fed out from the retractor, at an inner side of a skin material covering the frame. The bezel includes a through hole. The webbing extending from the retractor to an outer side of the skin material is configured to pass through the hole. The protruding portion extends from an inner face of the bezel toward the bracket.

In the configuration described above, when the vehicle is in a collision, for example, and a great load is placed on the webbing, displacement of the webbing is restricted by the bracket fixed to the frame. Note however, that a protruding portion that extends toward the bracket from the inner face of the bezel is provided. Also, this protruding portion is interposed between the bracket and the webbing. The webbing comes into contact primarily with the bezel and the protruding portion thereof, and coming into contact with the bracket is forbidden or suppressed.

In the seatbelt device according to the first aspect of the present disclosure, the bezel and the protruding portion may be integrally configured. Generally, in comparison with the frame that is a structural member, the skin material covering thereupon is flexible. Therefore, the bezel fixed to the skin material is capable of displacement along with the webbing. That is to say, the protruding portion integrally configured with the bezel is also capable of displacement along with the webbing. Thus, unlike the bracket fixed to the frame, the webbing does not come into intense contact (i.e., with a great relative velocity) with the bezel and the protruding portion thereof. Thus, damage of the webbing is effectively suppressed.

In the seatbelt device according to the first aspect of the present disclosure, the frame may be a seat frame disposed within a seat of the vehicle. Also, the protruding portion may be configured to be fixed to a seat skin material provided along a surface of the seat.

In the seatbelt device according to the first aspect of the present disclosure, an elastic modulus of a material for consisting the protruding portion may be lower than that of a material for consisting the bracket.

In the seatbelt device according to the first aspect of the present disclosure, the bracket may consist of a metal material. The protruding portion may consist of a resin material.

In the seatbelt device according to the first aspect of the present disclosure, the bracket may be configured to be situated forward of the frame. The webbing may be configured to extend passing between the frame and the bracket.

In the seatbelt device according to the first aspect of the present disclosure, the bracket may include a bent portion at a position facing the webbing. The protruding portion may be configured to be interposed between the bent portion of the bracket and the webbing.

In the seatbelt device according to the first aspect of the present disclosure, the bracket may include a pair of side portions that extends forward from the frame at both sides of the webbing, and a front portion extending between the side portions forward of the webbing. The bent portion may be configured to be situated at a connecting portion of one of the side portions and the front portion.

In the seatbelt device according to the first aspect of the present disclosure, the protruding portion may include a cross-sectional shape that is bent in an L-shape, and extend from the bezel toward the bracket.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 illustrates a seatbelt device 10 according to an embodiment employed in a seat 2 of a vehicle;

FIG. 2 is a cross-sectional view taken along line II-II in FIG. 1, in which an outer view of a retractor 14 is illustrated;

FIG. 3 is a frontal view illustrating a bracket 20 and a bezel 30;

FIG. 4 is a cross-sectional view taken along line IV-IV in FIG. 3; and

FIG. 5 is a diagram exemplifying the way in which webbing 12 is displaced toward the bracket 20, in the same cross-sectional position as in FIG. 3.

### DETAILED DESCRIPTION OF EMBODIMENTS

In an embodiment of the present technology, a frame may be a seat frame disposed within a seat of a vehicle. In this case, a protruding portion may be configured to be fixed to a seat skin material provided along a surface of the seat. Note however, that as another embodiment, the frame may be a frame configuring a vehicle body, and the skin material may be an interior panel covering the frame.

In an embodiment of the present technology, an elastic modulus of a material for consisting the protruding portion may include lower than that of a material for consisting a bracket. That is to say, a material making up a bezel may have a higher flexibility than the material making up the bracket. With such a configuration, damage that webbing receives from the protruding portion can be reduced. Also, due to the material making up the bracket having relatively high rigidity, unintended displacement of the webbing can be suppressed more.

In the embodiments described above, the bracket may consists of a metal material. In this case, the protruding portion may consists of a resin material. Note however, that the combination of materials making up the bracket and the protruding portion is not limited to the combination of a metal material and a resin material. The materials making up the bracket and the protruding portion may both be resin for example, or may both be metal, as long as the material making up the protruding portion has a lower elastic modulus than the material making up the bracket.

In an embodiment of the present technology, the bracket may be configured to be situated forward of the frame. Also, the webbing may be configured to extend passing between the frame and the bracket. With this configuration, when the webbing is displaced forward in a frontal collision of the vehicle, displacement of the webbing can be restricted with sureness by the bracket situated forward of the webbing.

In an embodiment of the present technology, the bracket may include a bent portion at a position facing the webbing. In this case, the protruding portion may be configured to be interposed between the bent portion of the bracket and the webbing. When the bracket has the bent portion, the webbing is readily damaged by coming into contact with the bent portion. Damage to the webbing can be effectively reduced by the protruding portion being interposed between the bent portion of the bracket and the webbing.

In an embodiment of the present technology, the bracket may include a pair of side portions that extends forward from the frame at both sides of the webbing, and a front portion extending between the side portions forward of the webbing. In this case, the bent portion may be configured to be situated at a connecting portion between one of the side portions and the front portion. Due to the bracket having a generally U-shaped form, unintended displacement of the webbing can be restricted from many directions. Further, due to the protruding portion being provided along with the bent portion of this U-shaped form, damage of the webbing can be effectively reduced.

In the embodiments described above, the protruding portion may include a cross-sectional shape that is bent in an L-shape, and extend from the bezel toward the bracket. With such a configuration, the webbing can be forbidden or suppressed from coming into contact with the bracket more surely, even when the direction of displacement of the webbing can change over a certain range. Also, the protruding portion also bends to follow the bent portion of the bracket, and accordingly, the protruding portion is kept from being locally subjected to an excessively great load when the protruding portion is caught between the webbing and the bracket.

### Embodiment

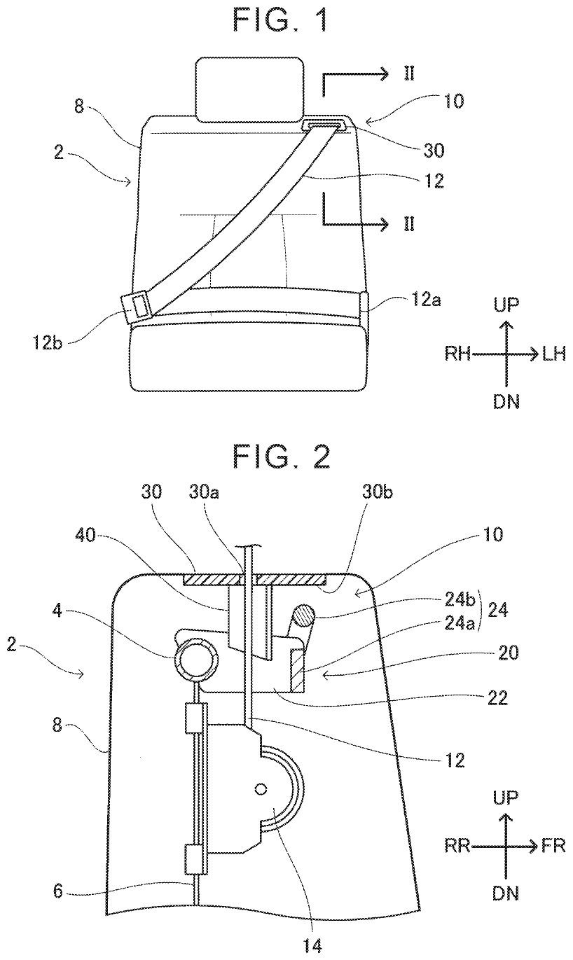

A seatbelt device 10 according to an embodiment will be described with reference to the drawings. The seatbelt device 10 according to the present embodiment is provided to a seat 2 of a vehicle, as illustrated in FIGS. 1 and 2. Also, the seatbelt device 10 is worn by an occupant (omitted from illustration) seated on the seat 2. The seatbelt device 10 restrains the occupant to the seat 2, thereby suppressing the occupant from moving forward of the seat 2 and the upper body of the occupant from excessively tilting forward. Note that the term “vehicle” as used here typically refers to a vehicle that travels over a road surface. However, the seatbelt device 10 according to the present embodiment can also be employed in a vehicle that travels over a track.

Note that here, the direction FR in the drawings indicates forward in the front-rear direction (vehicle-length direction) of the vehicle. The direction RR indicates rearward in the front-rear direction of the vehicle. Also, the direction LH indicates leftward in the right-left direction (vehicle-width direction) of the vehicle. The direction RH indicates rightward in the right-left direction of the vehicle. The direction UP indicates upward in the up-down direction (vehicle-height direction) of the vehicle. The direction DN indicates downward in the up-down direction of the vehicle. Note that in the present specification, the front-rear direction, the right-left direction, and the up-down direction, of the vehicle may be referred to simply as the front-rear direction, the right-left direction, and the up-down direction, respectively.

As illustrated in FIGS. 1 and 2, the seatbelt device 10 primarily is provided with webbing 12, a retractor 14, a bracket 20, and a bezel 30. The webbing 12 is a belt-like elongated member, and is also referred to as a strap. The webbing 12 is disposed following the body of the occupant. The webbing 12 restrains the occupant to the seat 2. In one example, the webbing 12 according to the present embodiment is made of a woven textile of synthetic fiber. The webbing 12 is pulled out from the inside of the seat 2. A distal end 12a of the webbing 12 is fixed to a lower portion of the seat 2. A buckle 12b that is detachably fixed to the seat 2 is provided at an intermediate position of the webbing 12.

The retractor 14 is disposed inside the seat 2. The retractor 14 is held by a seat frame 4 situated inside the seat 2 and a seat spring 6 connected to the seat frame 4, although this is not limiting in particular. The retractor 14 is a take-up device for the webbing 12. The retractor 14 stores the webbing 12 so as to be capable of being fed out. When the occupant pulls the webbing 12, the webbing 12 is fed out from the retractor 14. When the occupant loosens the pulling force, the webbing 12 is stored by the retractor 14. Also, the retractor 14 is configured such that when the feeding speed of the webbing 12 exceeds a predetermined value, the webbing 12 is locked. The specific configuration of the retractor 14 is not limited in particular. The retractor 14 may further be provided with additional configurations, such as a pretensioner and a load limiter.

The bracket 20 is fixed to the seat frame 4, and is situated on the inner side of a seat skin material 8 that covers the seat frame 4. The bracket 20 regulates the range of passage of the webbing 12 fed out from the retractor 14 on the inner side of the seat skin material 8, i.e., inside the seat 2. The bracket 20 according to the present embodiment is situated forward of the seat frame 4, although this is not limiting in particular. The webbing 12 extends passing between the seat frame 4 and the bracket 20. The bracket 20 according to the present embodiment is made of a metal material, the same as the seat frame 4. Note however, that the material making the bracket 20 is not limited to a metal material. The configuration of the bracket 20 will be described later in detail.

The bezel 30 is a generally plate-shaped member, and is fixed to the seat skin material 8 covering the surface of the seat 2. A through hole 30a is provided in the bezel 30. The webbing 12 extends from between the bracket 20 and the seat frame 4 situated inside the seat 2, through the through hole 30a of the bezel 30, and to the outer side of the seat skin material 8 (i.e., to the outside of the seat 2). The bezel 30 in the present embodiment is made of a resin material. However, the material that the bezel 30 is made of is not limited to a resin material. A protruding portion 40 is provided on an inner face 30b of the bezel 30. The protruding portion 40 extends toward the bracket 20, and is interposed between the bracket 20 and the webbing 12. The protruding portion 40 is integrally configured with the bezel 30, although this is not limiting in particular. Note that the inner face 30b of the bezel 30 means the face of the bezel 30 facing the inside of the seat 2. Also, the protruding portion 40 may be made of a resin material in the same way as the bezel 30. However, the material of which the protruding portion 40 is made is not limited to a resin material. The protruding portion 40 is fixed to the seat skin material 8 through the bezel 30.

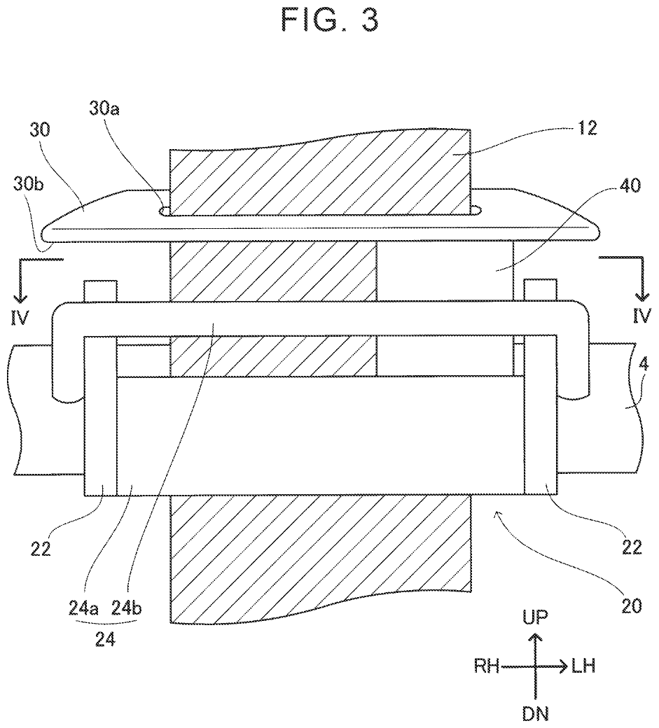

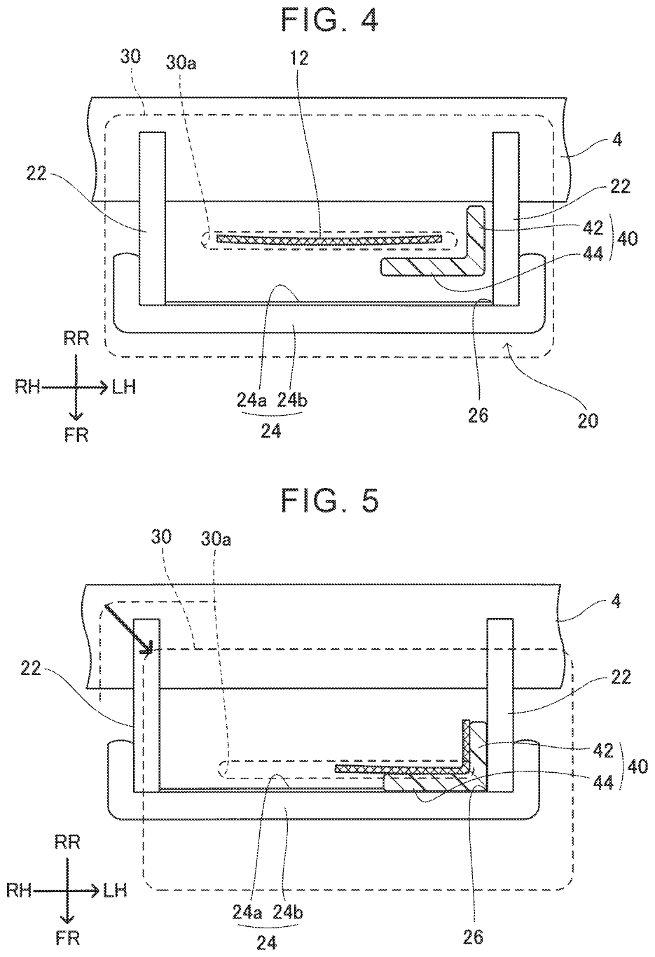

The bracket 20 and the bezel 30 will be described in detail with reference to FIGS. 3 and 4. The bracket 20 has a generally U-shaped form (see FIG. 4). Also, the bracket 20 has a pair of side portions 22 and a front portion 24. The side portions 22 are situated on both sides of the webbing 12 in the right-left direction. The side portions 22 extend forward from the seat frame 4. The front portion 24 extends between the side portions 22 forward of the webbing 12. Thus, a bent portion 26 that faces the webbing 12 is formed at a connection portion between one of the side portions 22 and the front portion 24. In one example, the front portion 24 includes a plate-shaped portion 24a having a rectangular cross-sectional shape, and a rod-shaped portion 24b that has a circular cross-sectional shape. The bracket 20 faces the webbing 12 from the front and both right and left direction sides. That is to say, a closed region that the webbing 12 is to pass through is defined by the seat frame 4 and the bracket 20. With the configuration, the range that the webbing 12 passes through inside the seat 2 is regulated by a closed region surrounded by the seat frame 4 and the bracket 20.

As described above, the protruding portion 40 that is interposed between the bracket 20 and the webbing 12 is provided to the inner face 30b of the bezel 30. In particular, the protruding portion 40 according to the present embodiment is interposed between the bent portion 26 of the bracket 20 and the webbing 12. The protruding portion 40 has a cross-sectional shape that is bent in the L-shape, so as to follow the bent portion 26 of the bracket 20. Note that the term cross-sectional shape as used here means the form of a cross-section perpendicular to the direction in which the protruding portion 40 extends from the bezel 30 toward the bracket 20. The direction in which the protruding portion 40 extends is generally downward in the up-down direction, and is parallel to the longitudinal direction of the webbing 12 adjacent to the protruding portion 40. The webbing 12 is normally disposed away from the protruding portion 40, with a gap formed between the two, although this is not limiting in particular. The protruding portion 40 also is disposed away from the bracket 20, with a gap formed between the two.

On the other hand, when the vehicle is in a collision, for example, and a great load is placed on the webbing 12, the webbing 12 is displaced toward the front of the seat 2. The seat skin material 8 itself is relatively flexible. Therefore, the bezel 30 fixed to the seat skin material 8 is not able to substantially regulate the forward displacement of the webbing 12. As a result, within the seat 2 the webbing 12 is displaced forward, but further displacement of the webbing 12 is restricted by the bracket 20 fixed to the seat frame 4, as illustrated in FIG. 5. At this time, the protruding portion 40 provided to the bezel 30 is interposed between the bracket 20 and the webbing 12. Contact of the webbing 12 with the bracket 20 is forbidden or suppressed, and accordingly damage due to contact with the bracket 20 is suppressed.

At the same time, the webbing 12 comes into contact with the protruding portion 40 instead of the bracket 20, and damage of the webbing 12 due to contact with the protruding portion 40 may occur. However, in comparison with the seat frame 4 that is a structural member of the seat 2, the seat skin material 8 covering thereupon is flexible. Thus, the bezel 30 fixed to the seat skin material 8 is capable of displacement along with the webbing 12, unlike the bracket 20 fixed to the seat frame 4. That is to say, the protruding portion 40 integrally configured with the bezel 30 is also capable of displacement with the webbing 12. Thus, the relative speed between the webbing 12 and the protruding portion 40 when the webbing 12 comes into contact with the protruding portion 40 is smaller than the relative speed between the webbing 12 and the bracket 20 when the webbing 12 comes into direct contact with the bracket 20. Thus, the protruding portion 40 provided to the bezel 30 does not come into intense contact (i.e., with a great relative velocity) with the webbing 12. Also, the relative displacement between the webbing 12 and the protruding portion 40 is relatively small. Therefore, little unintended folding or twisting of the webbing 12 occurs when the webbing 12 and the protruding portion 40 come into contact. Thus, according to the configuration of the present embodiment, damage to the webbing 12 is effectively suppressed as compared to when the webbing 12 comes into direct contact with the bracket 20.

In the seatbelt device 10 according to the present embodiment, the bracket 20 is made of a metal material, and the bezel 30 and the protruding portion 40 are made of a resin material. That is to say, the material making up the bezel 30 (the material making up the protruding portion 40 in particular) has a lower elastic modulus than the material making up the bracket 20. That is to say, the material making up the bezel 30 and the protruding portion 40 has relatively high flexibility. Thus, damage that the webbing 12 receives from the bezel 30 and the protruding portion 40 thereof can be reduced. Also, due to the material making up the bracket 20 having relatively high rigidity, unintended displacement of the webbing 12 can be suppressed more.

In the seatbelt device 10 according to the present embodiment, the bracket 20 has the bent portion 26 at a position facing the webbing 12, as described above. Due to the bracket 20 having the bent portion 26, folding or twisting of the webbing 12 readily occurs by the webbing 12 coming into contact with the bent portion 26 for example, and the webbing 12 is readily damaged. With regard to this point, the protruding portion 40 can effectively reduce damage to the webbing 12 by being interposed between the bent portion 26 of the bracket 20 and the webbing 12.

In the seatbelt device 10 according to the present embodiment, the protruding portion 40 has a cross-sectional shape that is bent in the L-shape, so as to follow the bent portion 26 of the bracket 20, as described above. In more detail, the protruding portion 40 has an upright wall 42 that extends along the front-rear direction, and a side wall 44 that extends in the right-left direction from the front end of the upright wall 42, as illustrated in FIGS. 4 and 5. The upright wall 42 faces the webbing 12 from the left side. The side wall 44 faces the webbing 12 from the front side. With such a configuration, the webbing 12 can be forbidden or suppressed from coming into contact with the bracket 20 more surely, even when the direction of displacement of the webbing 12 can change over a certain range. The protruding portion 40 also bends to follow the bent portion 26 of the bracket 20. Thus, the protruding portion 40 is kept from being locally subjected to an excessively great load when the protruding portion 40 is caught between the webbing 12 and the bracket 20 (see FIG. 5).

Although the seatbelt device 10 according to the present embodiment is a configuration attached to the seat 2 of a vehicle, this is not limiting. For example, the seatbelt device 10 may be attached to a vehicle body of a vehicle. In this case, The bracket 20 may be fixed to a frame making up the vehicle body (e.g., a pillar), for example. Also, the bezel 30 may be fixed to a skin material covering this frame (so-called lining). The bracket 20 may be fixed to any frame within the vehicle. The bezel 30 may be fixed to any skin material covering the frame.

Although embodiments of the present technology have been described above in detail, these are only exemplifications, and do not limit the Claims. The technology set forth in the Claims includes various modifications and alterations of the specific example exemplified above. Technical elements described in the present specification or the drawings exhibit technical utility, either singularly or through various types of combinations, and do not limit combinations set forth in the Claims at the time of application. Also, the technology exemplified in the present specification or the drawings may achieve a plurality of objects simultaneously, and achieving one of these objects in itself has technical utility.

What is claimed is:

1. A seatbelt device for a vehicle, the seatbelt device comprising:
a retractor configured to store webbing;
a bracket configured to
be fixed to a frame within the vehicle, and
regulate a passage range of the webbing fed out from the retractor, at an inner side of a skin material covering the frame;
a bezel configured to be fixed to the skin material, the bezel including a through hole, the webbing extending from the retractor to an outer side of the skin material being configured to pass through the through hole; and
a protruding portion configured to be interposed between the bracket and the webbing, the protruding portion extending from an inner face of the bezel toward the bracket.

2. The seatbelt device according to claim 1, wherein the bezel and the protruding portion are integrally configured.

3. The seatbelt device according to claim 1, wherein:
the frame is a seat frame disposed within a seat of the vehicle; and
the protruding portion is configured to be fixed to a seat skin material provided along a surface of the seat.

4. The seatbelt device according to claim 1, wherein an elastic modulus of a material for consisting the protruding portion is lower than that of a material for consisting the bracket.

5. The seatbelt device according to claim 4, wherein:
the bracket consists of a metal material; and
the protruding portion consists of a resin material.

6. The seatbelt device according to claim 1, wherein:
the bracket is configured to be situated forward of the frame; and
the webbing is configured to extend passing between the frame and the bracket.

7. The seatbelt device according to claim 6, wherein:
the bracket includes a bent portion at a position facing the webbing; and
the protruding portion is configured to be interposed between the bent portion of the bracket and the webbing.

8. The seatbelt device according to claim 7, wherein:
the bracket includes a pair of side portions that extends forward from the frame at both sides of the webbing, and a front portion extending between the side portions forward of the webbing; and
the bent portion is configured to be situated at a connecting portion between one of the side portions and the front portion.

9. The seatbelt device according to claim 7, wherein the protruding portion includes a cross-sectional shape that is bent in an L-shape, and extends from the bezel toward the bracket.
